(19) United States
(12) Patent Application Publication
(10) Pub. No.: US 2013/0012638 A1
(43) Pub. Date: Jan. 10, 2013

(54) METHODS OF DECREASING VISCOSITY OF A POLYARYLENE SULFIDE-CONTAINING POLYMER MELT

(75) Inventors: Joachim C. Ritter, Wilmington, DE (US); Joel M. Pollino, Alpharetta, GA (US); Michael T. Pottiger, Media, PA (US); Zheng-Zheng Huang, Hockessin, DE (US); Lakshmi Krishnamurthy, Wilmington, DE (US); John C. Howe, Bear, DE (US); Marios Avgousti, Kennett Square, PA (US); Zuohong Yin, West Chester, PA (US)

(73) Assignee: E I DU PONT DE NEMOURS AND COMPANY, Wilmington, DE (US)

(21) Appl. No.: 13/636,233

(22) PCT Filed: Mar. 16, 2011
(86) PCT No.: PCT/US11/28602

§ 371 Date: Sep. 20, 2012

Related U.S. Application Data
(60) Provisional application No. 61/316,050, filed on Mar. 22, 2010.

(51) Int. Cl. C08L 81/04; C08K 5/098; C08K 3/22

(52) U.S. Cl. 524/399

(57) ABSTRACT

This invention relates to methods for decreasing the complex viscosity of a polyarylene sulfide polymer melt while maintaining the molecular weight of the polyarylene sulfide with time. This invention also relates to polymer melt compositions comprising a polyarylene sulfide, wherein the complex viscosity of the composition is decreased relative to the complex viscosity of the native polyarylene sulfide measured under the same conditions, and the weight average molecular weight of the polyarylene sulfide is maintained. The methods of decreasing the complex viscosity of a polyarylene sulfide-containing polymer melt, and the polymer melt compositions so obtained, are useful in processes to produce fibers, films, nonwovens, and molded parts from polyarylene sulfides.

### FIELD

This invention relates to methods for decreasing the viscosity of a polyarylene sulfide melt.

### BACKGROUND

Polyphenylene sulfide (PPS) is a commercially-available thermoplastic polymer that is widely used for film, fiber, injection molding, and composite applications due to its high chemical resistance, excellent mechanical properties, and good thermal properties. In the presence of air and at elevated temperatures, the thermal and thermooxidative stability of PPS is considerably reduced. Typically, PPS is processed in the melt at about 300° C. or higher, and partial decomposition can occur, resulting in loss of polymer properties and reduced productivity.

In applications such as the production of fibers, films, nonwovens, and molded parts from polyarylene sulfide resins such as PPS, it is desirable that the molecular weight of the polymer resin remain substantially unchanged during processing of the polymer. Various procedures have been utilized to stabilize polyarylene sulfide compositions such as polyphenylene sulfide against changes in physical properties during polymer processing.

U.S. Pat. No. 4,411,853 discloses that the heat stability of arylene sulfide resins is improved by the addition of an effective stabilizing amount of at least one organotin compound which retards curing and cross-linking of the resin during heating. A number of dialkyltin dicarboxylate compounds used as cure retarders and heat stabilizers are disclosed, as well as di-n-butyltin-S,S′-bis(isooctyl thioacetate) and di-n-butyltin-S,S′-bis(isooctyl-3-thiopropionate.

U.S. Pat. No. 4,418,029 discloses that the heat stability of arylene sulfide resins is improved by the addition of cure retarders comprising Group IIA or Group IIB metal salts of fatty acids represented by the structure [CH₃(CH₂)ₙCOO—]—₂M, where M is a Group IIA or Group IIB metal and n is an integer from 8 to 18. The effectiveness of zinc stearate, magnesium stearate, and calcium stearate is disclosed.

U.S. Pat. No. 4,426,479 relates to a chemically stabilized poly-p-phenylene sulfide resin composition and a film made thereof. The reference discloses that the PPS resin composition should contain at least one metal component selected from the group consisting of zinc, lead, magnesium, manganese, barium, and tin, in a total amount of from 0.05 to 40 wt %. These metal components may be contained in any form.

U.S. Pat. Nos. 3,405,073 and 3,489,702 relate to compositions useful in the enhancement of the resistance of ethylene sulfide polymers to heat deterioration. Such polymers are composed of ethylene sulfide units linked in a long chain (CH₂CH₂—S)ₙ, where n represents the number of such units in the chain, and are thus of the nature of polymeric ethylene thioethers. The references note that the utility of these polymers as plastic materials for industrial applications is seriously limited, however, due to their lack of adequate mechanical strength. The references disclose that an organotin compound having organic radicals attached to tin through oxygen, such as a tin carboxylate, phenolate or alcoholate, is employed to enhance resistance to heat deterioration of ethylene sulfide polymers. The references note that the efficacy of the organotin compounds is frequently enhanced by a compound of another polyvalent metal, or another tin compound. The second polyvalent metal can be any metal selected from Groups II to VIII of the Periodic Table. Given the different chemical reactivity and physical properties of ethylene sulfide polymers as compared to polyarylene sulfides, it would not be obvious that the same additives would have the same effect in polyarylene sulfides as in ethylene sulfide polymers.

In light of the decomposition of polyarylene sulfides which can occur at typical processing temperatures, it is desirable to use a lower processing temperature. Stated another way, it is desirable to decrease the viscosity of a polymer melt comprising polyarylene sulfide so that polymer processing can be performed at lower temperatures where the thermal and thermooxidative stability of the polyarylene sulfide are improved. Being able to process a lower viscosity polyarylene sulfide melt also offers the advantage of lower pressure drop during fiber spinning and improved flow during injection molding. Also desired are methods of reducing polyarylene sulfide melt viscosity while maintaining the molecular weight of the polyarylene sulfide with time.

### SUMMARY

This invention provides methods for decreasing the complex viscosity of a polymer composition comprising polyarylene sulfide while maintaining the weight average molecular weight of the polyarylene sulfide. The present invention also provides a polymer melt composition comprising: a) a polyarylene sulfide having certain weight average molecular weight and complex viscosity characteristics, and b) at least one tin additive comprising a branched tin(II) carboxylate. The complex viscosity of the melt composition is decreased compared to that of the native polyarylene sulfide measured under the same conditions; and the retention of the weight average molecular weight of the polyarylene sulfide in the composition is at least about 80% when measured according to the Accelerated Aging Test defined herein.

In one embodiment, this invention provides a method for decreasing the complex viscosity of a polymer composition comprising polyarylene sulfide by combining (a) a polyarylene sulfide having a weight average molecular weight in the range of about 50,000 g/mol to about 80,000 g/mol and a complex viscosity in the range of about 200 Pa·s to about 900 Pa·s when measured according to the Complex Viscosity Test defined herein; and (b) at least one additive selected from the group consisting of tin(IV) oxide, tin(II) oxide, tin(II) stearate, zinc stearate, zinc acetate, zinc oxide, a branched tin(II) carboxylate; and mixtures thereof, to form a polymer composition.

This invention relates to methods for decreasing the viscosity of a polyarylene sulfide melt while maintaining the molecular weight of the polyarylene sulfide with time. Combining certain additives with polyarylene sulfide has been found to decrease the complex viscosity of the composition by at least about 10% as compared to the complex viscosity of native polyarylene sulfide measured under the same conditions.

### DETAILED DESCRIPTION

This invention relates to methods for decreasing the complex viscosity of a polyarylene sulfide polymer melt while maintaining the molecular weight of the polyarylene sulfide with time. The present invention also relates to polymer melt compositions comprising a polyarylene sulfide and at least one tin additive comprising a branched tin(II) carboxylate, wherein the complex viscosity of the composition is decreased relative to the complex viscosity of a native polyarylene sulfide measured under the same conditions, and the weight average molecular weight of the polyarylene sulfide is maintained with time. The methods for decreasing the complex viscosity of a polyarylene sulfide-containing polymer melt, and the polymer melt compositions so obtained, are useful in processes to produce fibers, films, coatings, nonwovens, and molded parts from polyarylene sulfides.

Where the indefinite article “a” or “an” is used with respect to a statement or description of the presence of a step in a process of this invention, it is to be understood, unless the statement or description explicitly provides to the contrary, that the use of such indefinite article does not limit the presence of the step in the process to one in number.

Where a range of numerical values is recited herein, unless otherwise stated, the range is intended to include the endpoints thereof, and all integers and fractions within the range. It is not intended that the scope of the invention be limited to the specific values recited when defining a range.

The following definitions are used herein and should be referred to for interpretation of the claims and the specification.

The term “PAS” means polyarylene sulfide.

The term “PPS” means polyphenylene sulfide.

The term “native” refers to a polymer which does not contain any additives.

The term “secondary carbon atom” means a carbon atom that is bonded to two other carbon atoms with single bonds.

The term “tertiary carbon atom” means a carbon atom that is bonded to three other carbon atoms with single bonds.

The term “thermal stability”, as used herein, refers to the degree of change in the weight average molecular weight of a PAS polymer induced by elevated temperatures in the absence of oxygen. As the thermal stability of a given PAS polymer improves, the degree to which the polymer's weight average molecular weight changes over time decreases. Generally, in the absence of oxygen, changes in molecular weight are often considered to be largely due to chain scission, which typically decreases the molecular weight of a PAS polymer.

The term “thermo-oxidative stability”, as used herein, refers to the degree of change in the weight average molecular weight of a PAS polymer induced by elevated temperatures in the presence of oxygen. As the thermo-oxidative stability of a given PAS polymer improves, the degree to which the polymer's weight average molecular weight changes over time decreases. Generally, in the presence of oxygen, changes in molecular weight may be due to a combination of oxidation of the polymer and chain scission. As oxidation of the polymer typically results in cross-linking, which increases molecular weight, and chain scission typically decreases the molecular weight, changes in molecular weight of a polymer at elevated temperatures in the presence of oxygen may be challenging to interpret.

The term “° C.” means degrees Celsius.

The term “kg” means kilogram(s).

The term “g” means gram(s).

The term “mg” means milligram(s).

The term “mol” means mole(s).

The term “s” means second(s).

The term “min” means minute(s).

The term “hr” means hour(s).

The term “rpm” means revolutions per minute.

The term “rad” means radians.

The term “Pa” means pascals.

The term “psi” means pounds per square inch.

The term “mL” means milliliter(s).

The term “ft” means foot.

The term “weight percent” as used herein refers to the weight of a constituent of a composition relative to the entire weight of the composition unless otherwise indicated. Weight percent is abbreviated as “wt %”.

Polyarylene sulfides (PAS) include linear, branched or cross linked polymers that include arylene sulfide units. Polyarylene sulfide polymers and their synthesis are known in the art and such polymers are commercially available.

Exemplary polyarylene sulfides useful in the invention include polyarylene thioethers containing repeat units of the formula —[(Ar¹)ₙ—X]ₘ—[(Ar²)ᵢ—Y]ⱼ—(Ar³)ₖ—Z]ₗ—[(Ar⁴)ₒ—W]ₚ— wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, l, o, and p are independently zero or 1, 2, 3, or 4, subject to the proviso that their sum total is not less than 2. The arylene units Ar¹, Ar², Ar³, and Ar⁴ may be selectively substituted or unsubstituted. Advantageous arylene systems are phenylene, biphenylene, naphthylene, anthracene and phenanthrene. The polyarylene sulfide typically includes at least 30 mol %, particularly at least 50 mol % and more particularly at least 70 mol % arylene sulfide (—S—) units. Preferably the polyarylene sulfide polymer includes at least 85 mol % sulfide linkages attached directly to two aromatic rings. Advantageously the polyarylene sulfide polymer is polyphenylene sulfide (PPS), defined herein as containing the phenylene sulfide structure —(C₆H₄—S)ₙ— wherein n is an integer of 1 or more) as a component thereof.

A polyarylene sulfide polymer having one type of arylene group as a main component can be preferably used. However, in view of processability and heat resistance, a copolymer containing two or more types of arylene groups can also be used. A PPS resin comprising, as a main constituent, a p-phenylene sulfide recurring unit is particularly preferred since it has excellent processability and is industrially easily obtained. In addition, a polyarylene ketone sulfide, polyarylene ketone ketone sulfide, polyarylene sulfide sulfone, and the like can also be used.

Specific examples of possible copolymers include a random or block copolymer having a p-phenylene sulfide recurring unit and an m-phenylene sulfide recurring unit, a random or block copolymer having a phenylene sulfide recurring unit and an arylene ketone sulfide recurring unit, a random or block copolymer having a phenylene sulfide recurring unit and an arylene ketone ketone sulfide recurring unit, and a random or block copolymer having a phenylene sulfide recurring unit and an arylene sulfone sulfide recurring unit.

The polyarylene sulfides may optionally include other components not adversely affecting the desired properties thereof. Exemplary materials that could be used as additional components would include, without limitation, antimicrobials, pigments, antioxidants, surfactants, waxes, flow promoters, particulates, and other materials added to enhance processability of the polymer. These and other additives can be used in conventional amounts.

As noted above, PPS is an example of a polyarylene sulfide. PPS is an engineering thermoplastic polymer that is widely used for film, fiber, injection molding, and composite applications due to its high chemical resistance, excellent mechanical properties, and good thermal properties. However, the thermal and oxidative stability of PPS is considerably reduced in the presence of air and at elevated temperature conditions. Under these conditions, severe degradation can occur, leading to the embitterment of PPS material and severe loss of strength. Improved thermal and oxidative stability of PPS at elevated temperatures and in the presence of air are desired.

In one embodiment, the present invention provides methods for decreasing the complex viscosity of a polyarylene sulfide polymer melt while maintaining the molecular weight of the polyarylene sulfide with time. A decrease in the complex viscosity of a polyarylene sulfide polymer melt is desirable for a variety of reasons, including the ability to process the melt at a lower temperature and with lower pressure drop during fiber forming. Changes with time in the molecular weight of a polyarylene sulfide polymer heated in the presence of nitrogen are an indicator of the thermal stability of the polyarylene sulfide, with larger changes in molecular weight indicating lower thermal stability. The extent to which a polymer melt can maintain the initial molecular weight of the polyarylene sulfide with time demonstrates the degree of thermal stability of the polymer melt.

In one embodiment of the method, a a polyarylene sulfide having a weight average molecular weight in the range of about 50,000 g/mol to about 80,000 g/mol and a complex viscosity in the range of about 200 Pa·s to about 900 Pa·s, when measured according to the Complex Viscosity Test defined herein below, is combined with at least one additive as specified herein below to form a polymer composition. The complex viscosity of the polymer composition is decreased compared to the complex viscosity of the native polyarylene sulfide measured under the same conditions, and the retention of the weight average molecular weight of the polyarylene sulfide in the composition is at least about 77% when measured according to the Accelerated Aging Test defined herein below.

The term “measured under the same conditions”, as used herein, means that the complex viscosity of the polymer composition comprising the additive and the complex viscosity of the native polyarylene sulfide are measured in accordance with ASTM D4440 at the same temperature and at the same frequency and strain. The measurements may be made according to the Complex Viscosity Test defined herein or at a temperature, frequency, and strain which are different from those of the Complex Viscosity Test.

The additive(s) and the polyarylene sulfide may be preblended as a dry mixture before forming the polymer melt. Alternatively, the additive may be compounded with the polyarylene sulfide in a masterbatch formulation, then diluted with additional polyarylene sulfide, as dry solids or as melts. Generally, the additive is present in the polymer composition at a concentration of about 5 weight percent or less, based on the weight of the polyarylene sulfide. For example, the additive may be present in the polymer composition at a concentration from about 0.1 weight percent to about 5 weight percent, of from about 0.1 weight percent to about 4 weight percent, or from about 0.1 weight percent to about 3 weight percent, or from about 0.1 weight percent to about 2 weight percent, or from about 0.1 to about 1 weight percent. Typically, the concentration of the additive may be higher in a master batch composition, for example from about 5 weight percent to about 10 weight percent, or higher. The additive may be added to the molten or solid polyarylene sulfide as a solid, as a slurry, or as a solution.

In one embodiment, the at least one additive is selected from the group consisting of tin(IV) oxide, tin(II) oxide, tin(II) stearate, zinc stearate, zinc acetate, zinc oxide, a branched tin(II) carboxylate; and mixtures thereof. The additives may be obtained commercially. The choice of additive may depend on the desired polymer viscosity decrease.

In one embodiment, a polyarylene sulfide is combined with an additive comprising zinc acetate, whereby the complex viscosity of the composition is decreased by about 10% to about 20% relative to the complex viscosity of the native polyarylene sulfide measured under the same conditions.

In one embodiment, a polyarylene sulfide is combined with an additive comprising zinc stearate, whereby the complex viscosity of the composition is decreased by about 20% to about 30% relative to the complex viscosity of the native polyarylene sulfide measured under the same conditions.

In one embodiment, a polyarylene sulfide is combined with an additive comprising tin(II) stearate, whereby the complex viscosity of the composition is decreased by at least about 40% relative to the complex viscosity of the native polyarylene sulfide measured under the same conditions.

In one embodiment, the additive may comprise at least one tin additive comprising a branched tin(II) carboxylate selected from the group consisting of Sn(O₂CR)₂, Sn(O₂CR)(O₂CR′), Sn(O₂CR)(O₂CR″), and mixtures thereof, where the carboxylate moieties O₂CR and O₂CR′ independently represent branched carboxylate anions and the carboxylate moiety O₂CR″ represents a linear carboxylate anion. In one embodiment, the branched tin(II) carboxylate comprises Sn(O₂CR)₂, Sn(O₂CR)(O₂CR′), or a mixture thereof. In one embodiment, the branched tin(II) carboxylate comprises Sn(O₂CR)₂. In one embodiment, the branched tin(II) carboxylate comprises Sn(O₂CR)(O₂CR′). In one embodiment, the branched tin(II) carboxylate comprises Sn(O₂CR)(O₂CR″).

Optionally, the tin additive may further comprise a linear tin(II) carboxylate Sn(O₂CR″)₂. Generally, the relative amounts of the branched and linear tin(II) carboxylates are selected such that the sum of the branched carboxylate moieties [O₂CR+O₂CR′] is at least about 25% on a molar basis of the total carboxylate moieties [O₂CR+O₂CR′+O₂CR″] contained in the additive. For example, the sum of the branched carboxylate moieties may be at least about 33%, or at least about 40%, or at least about 50%, or at least about 66%, or at least about 75%, or at least about 90%, of the total carboxylate moieties contained in the tin additive.

In one embodiment, the radicals R and R′ both comprise from 6 to 30 carbon atoms and both contain at least one secondary or tertiary carbon. The secondary or tertiary carbon(s) may be located at any position(s) in the carboxylate moieties O₂CR and O₂CR′, for example in the position α to the carboxylate carbon, in the position ω to the carboxylate carbon, and at any intermediate position(s). The radicals R and R′ may be unsubstituted or may be optionally substituted with inert groups, for example with fluoride, chloride, bromide, iodide, nitro, hydroxyl, and carboxylate groups. Examples of suitable organic R and R′ groups include aliphatic, aromatic, cycloaliphatic, oxygen-containing heterocyclic, nitrogen-containing heterocyclic, and sulfur-containing heterocyclic radicals. The heterocyclic radicals may contain carbon and oxygen, nitrogen, or sulfur in the ring structure.

In one embodiment, the radical R″ is a primary alkyl group comprising from 6 to 30 carbon atoms, optionally substituted with inert groups, for example with fluoride, chloride, bromide, iodide, nitro, hydroxyl, and carboxylate groups. In one embodiment, the radical R″ is a primary alkyl group comprising from 6 to 20 carbon atoms.

In one embodiment, the radicals R or R′ independently or both have a structure represented by Formula (I),

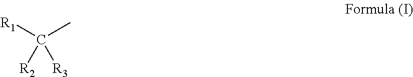

wherein R₁, R₂, and R₃ are independently:

H,

a primary, secondary, or tertiary alkyl group having from 6 to 18 carbon atoms, optionally substituted with fluoride, chloride, bromide, iodide, nitro, hydroxyl, and carboxyl groups;

an aromatic group having from 6 to 18 carbon atoms, optionally substituted with alkyl, fluoride, chloride, bromide, iodide, nitro, hydroxyl, and carboxyl groups; and

a cycloaliphatic group having from 6 to 18 carbon atoms, optionally substituted with fluoride, chloride, bromide, iodide, nitro, hydroxyl, and carboxyl groups;

with the proviso that when R₂ and R₃ are H, R₁ is:

a secondary or tertiary alkyl group having from 6 to 18 carbon atoms, optionally substituted with fluoride, chloride, bromide, iodide, nitro, hydroxyl, and carboxyl groups;

an aromatic group having from 6 to 18 carbons atoms and substituted with a secondary or tertiary alkyl group having from 6 to 18 carbon atoms, the aromatic group and/or the secondary or tertiary alkyl group being optionally substituted with fluoride, chloride, bromide, iodide, nitro, hydroxyl, and carboxyl groups; and

a cycloaliphatic group having from 6 to 18 carbon atoms, optionally substituted with fluoride, chloride, bromide, iodide, nitro, hydroxyl, and carboxyl groups.

In one embodiment, the radicals R or R′ or both have a structure represented by Formula (I), and R₃ is H.

In another embodiment, the radicals R or R′ or both have a structure represented by Formula (II),

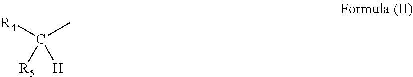

wherein

R₄ is a primary, secondary, or tertiary alkyl group having from 4 to 6 carbon atoms, optionally substituted with fluoride, chloride, bromide, iodide, nitro, and hydroxyl groups; and

R₅ is a methyl, ethyl, n-propyl, sec-propyl, n-butyl, sec-butyl, or tert-butyl group, optionally substituted with fluoride, chloride, bromide, iodide, nitro, and hydroxyl groups.

In one embodiment, the radicals R and R′ are the same and both have a structure represented by Formula (II), where R₄ is n-butyl and R₅ is ethyl. This embodiment describes the branched tin(II) carboxylate tin(II) 2-ethylhexanoate, also referred to herein as tin(II) ethylhexanoate.

The tin(II) carboxylate(s) may be obtained commercially, or may be generated in situ from an appropriate source of tin(II) cations and the carboxylic acid corresponding to the desired carboxylate(s).

In one embodiment, the polyarylene sulfide composition comprising the branched tin(II) carboxylate further comprises at least one zinc(II) compound and/or zinc metal [Zn(0)]. The zinc(II) compound may be an organic compound, for example zinc stearate, or an inorganic compound such as zinc sulfate or zinc oxide, as long as the organic or inorganic counter ions do not adversely affect the desired properties of the polyarylene sulfide composition. The zinc(II) compound may be obtained commercially, or may be generated in situ. Zinc metal may be used in the composition as a source of zinc(II) ions, alone or in conjunction with at least one zinc(II) compound. In one embodiment the zinc(II) compound is selected from the group consisting of zinc oxide, zinc stearate, and mixtures thereof.

The zinc(II) compound and/or zinc metal may be present in the polyarylene sulfide at a concentration of about 10 weight percent or less, based on the weight of the polyarylene sulfide. For example, the zinc(II) compound and/or zinc metal may be present at a concentration of about 0.01 weight percent to about 5 weight percent, or for example from about 0.25 weight percent to about 2 weight percent. Typically, the concentration of the zinc(II) compound and/or zinc metal may be higher in a master batch composition, for example from about 5 weight percent to about 10 weight percent, or higher. The at least one zinc(II) compound and/or zinc metal may be added to the molten or solid polyarylene sulfide as a solid, as a slurry, or as a solution. The zinc(II) compound and/or zinc metal may be added together with the tin(II) additive or separately.

In another embodiment, the present invention provides polymer melt compositions comprising a polyarylene sulfide having a weight average molecular weight in the range of about 50,000 g/mol to about 80,000 g/mol and a complex viscosity in the range of about 200 Pa·s to about 900 Pa·s when measured according to the Complex Viscosity Test defined herein, and at least one tin additive comprising a branched tin(II) carboxylate selected from the group consisting of Sn(O₂CR)₂, Sn(O₂CR)(O₂CR′), Sn(O₂CR)(O₂CR″), and mixtures thereof, where the carboxylate moieties O₂CR and O₂CR′ independently represent branched carboxylate anions and the carboxylate moiety O₂CR″ represents a linear carboxylate anion. The complex viscosity of the polymer composition is decreased compared to the complex viscosity of the native polyarylene sulfide measured under the same conditions, and the retention of the weight average molecular weight of the polyarylene sulfide in the composition is at least about 80% when measured according to the Accelerated Aging Test defined herein below. The definitions of R, R′, and R″ are as defined above.

In one embodiment, the additive further comprises a linear tin(II) carboxylate Sn(O₂CR″)₂ and R″ is as defined above. In one embodiment, the tin(II) carboxylate comprises Sn(O₂CR)₂, Sn(O₂CR)(O₂CR′), or mixtures thereof, and the radicals R or R′ are as defined above. In one embodiment, the tin(II) carboxylate comprises Sn(O₂CR)₂, and R has a structure represented by Formula (II), where R₄ is n-butyl and R₅ is ethyl. In one embodiment, the the complex viscosity of the polymer composition is decreased by at least about 30% relative to the complex viscosity of the native polyarylene sulfide measured under the same conditions. In one embodiment, the polymer composition further comprises at least one zinc(II) compound and/or zinc metal. In one embodiment, the zinc(II) compound comprises zinc stearate, the additive comprises Sn(O₂CR)₂, and R has a structure represented by Formula (II), where R₄ is n-butyl and R₅ is ethyl. In one embodiment, the polyarylene sulfide is polyphenylene sulfide.

Generally, the additive is present in the polymer melt composition at a concentration of about 5 weight percent or less, based on the weight of the polyarylene sulfide. For example, the additive may be present in the polymer melt composition at a concentration from about 0.1 weight percent to about 5 weight percent, of from about 0.1 weight percent to about 4 weight percent, or from about 0.1 weight percent to about 3 weight percent, or from about 0.1 weight percent to about 2 weight percent, or from about 0.1 to about 1 weight percent. Typically, the concentration of the additive may be higher in a master batch composition, for example from about 5 weight percent to about 10 weight percent, or higher. The additive may be added to the molten or solid polyarylene sulfide as a solid, as a slurry, or as a solution.

### EXAMPLES

The present invention is further defined in the following examples. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various uses and conditions.

### Materials

The following materials were used in the examples. All commercial materials were used as received unless otherwise indicated. Fortron® 309 polyphenylene sulfide and Fortron® 317 polyphenylene sulfide were obtained from Ticona (Florence, Ky.). Tin(II) 2-ethylhexanoate (90%), zinc acetate dihydrate (98%), calcium acetate dehydrate (98%) and zinc oxide (99%) were obtained from Sigma-Aldrich (St. Louis, Mo.). Tin(II) stearate (98%) was obtained from Acros Organics (Morris Plains, N.J.). Zinc stearate (99%) was obtained from Honeywell Reidel-de Haen (Seelze, Germany). Tin(IV)oxide (99.9%), tin(II)oxide (98%) and calcium stearate (85%) were obtained from Strem Chemicals (Newburyport, Mass.). Calcium carbonate was obtained from VWR International (West Chester Pa.).

Tin(II) 2-ethylhexanoate is also referred to herein as tin(II) ethylhexanoate.

For each Example and Comparative Example, different samples of the composition to be evaluated were used for complex viscosity and for molecular weight measurements.

### Analytical Methods

Complex viscosity was measured at 300° C. under nitrogen in accordance with ASTM D 4440 using a Malvern controlled-stress rotational rheometer equipped with an extended temperature cell (ETC) forced convection oven and 25 mm parallel plates with smooth surfaces. Plate temperature was calibrated using a disc made of nylon with a thermocouple embedded in the middle. Disks with a diameter of 25 mm and a thickness of 1.2 mm were prepared from pellets of the compositions of the Examples and the Comparative Examples by compression molding under vacuum at a temperature of 290° C. using a Dake heated laboratory press.

To perform complex viscosity measurements, a molded disk of the PPS composition was inserted between the parallel plates preheated to 300° C., the door of the forced convection oven was closed, the gap was changed to around 3200 μm to prevent curling of the disk, and the oven temperature was allowed to re-equilibrate to 300° C. The gap was then changed from 3200 to 1050 μm, the oven was opened, the edges of the sample were carefully trimmed, the oven was closed, the oven temperature was allowed to re-equilibrate to 300° C., the gap was adjusted to 1000 μm, and the measurement started. A time sweep was performed at a frequency of 6.283 rad/s using a strain of 10%. The measurement was performed in duplicate with a fresh sample loading each time and the average values are reported in Table 1. This method is referred to herein as the “Complex Viscosity Test”.

The change in viscosity was calculated as follows and expressed as a percentage:

Visc change(%)=[(Visc(control)−Visc(comp))/Visc(control)]×100

where Visc (control) is the viscosity of the native polyarylene sulfide measured at 180 s after the start of the test and Visc (comp) is the viscosity of the polyarylene sulfide composition containing the additive measured at 180 s after the start of the test. Visc (control) and Visc (comp) are measured under the same conditions.

The thermal stability of PPS compositions was assessed by measuring changes in molecular weight (MW) under nitrogen as a function of time using the method described herein, which is referred to as the “Accelerated Aging Test”. To assess changes in molecular weight, samples were heat-treated in nitrogen and compared with untreated samples. To heat-treat a sample, a 12″ aluminum block containing 17×28 mm holes was preheated in a nitrogen-purged dry box to 320° C. using an IKA hotplate. Pellets (0.5 g) of the compositions of the Examples and the Comparative Examples were placed in 40 mL vials (26 mm×95 mm) and inserted into the preheated block for 2 h, removed, and allowed to cool to room temperature. The resulting monolithic mass of heat-treated polymer was subsequently removed from each vial by immersion in liquid nitrogen followed by breaking the vial with a hammer after removal from the liquid nitrogen.

The molecular weights of the heat-treated and non-heat-treated samples were measured using an integrated multidetector SEC system PL-220TM from Polymer Laboratories Ltd., now a part of Varian Inc. (Church Stretton, UK). Constant temperature was maintained across the entire path of a polymer solution from the injector through the four on-line detectors: 1) a two-angle light scattering photometer, 2) a differential refractometer, 3) a differential capillary viscometer, and 4) an evaporative light scattering photometer (ELSD). The system was run with closed valves for the ELSD detector, so that only traces from the refractometer, viscometer and light scattering photometer were collected. Three chromatographic columns were used: two Mix-B PL-Gel columns and one 500A PL Gel column from Polymer Labs (10 μm particle size). The mobile phase was comprised of 1-chloronaphthalene (1-CNP) (Acros Organics), which was filtered through a 0.2 micron PTFE membrane filter prior to use. The oven temperature was set to 210° C.

Typically, a PPS sample was dissolved for 2 hours in 1-CNP at 250° C. with continuous moderate agitation without filtration (Automatic sample preparation system PL 260 TM from Polymer Laboratories). Subsequently, the hot sample solution was transferred into a hot (220° C.) 4 mL injection valve at which point it was immediately injected and eluted in the system. The following set of chromatographic conditions was employed: 1-CNP temperature: 220° C. at injector, 210° C. at columns and detectors; flow rate: 1 mL/min, sample concentration: 3 mg/mL, injection volume: 0.2 mL, run time: 40 min. Molecular weight distribution (MWD) and average molecular weights of PPS were then calculated using a multidetector SEC method implemented in Empower™ 2.0 Chromatography Data Manager from Waters Corp. (Milford, Mass.).

Molecular weight retention was calculated as follows and expressed as a percentage:

Mw Retention(%)=[1−[(Mw(initial)−Mw(final))/Mw(initial)]]×100

where Mw (initial) is the molecular weight of the composition at the start of the thermal stability test and Mw (final) is the molecular weight of the composition after aging for 2 hours at 320° C. in nitrogen.

In the Table, “Ex” means “Example” and “Comp Ex” means “Comparative Example”. A negative value for “Change in Complex Viscosity (%)” indicates that the complex viscosity of the sample is decreased relative to that for native PPS (Comparative Example A). A positive value for “Change in Complex Viscosity (%)” indicates that the complex viscosity of the sample is increased relative to that for native PPS (Comparative Example A).

Values are reported as average value +/− uncertainty. Following standard convention, the uncertainty was rounded to 1 significant figure and the average value was rounded to the same number of decimal places as the uncertainty. The average values reported in the Table are the mean obtained from a minimum of two runs and the uncertainty is the standard error of the mean. For the weight average molecular weight the uncertainty is 1000 g/mol and for the complex viscosity the uncertainty is 10 Pa·s.

### Example 1

### PPS Containing Tin(II) Ethylhexanoate

This Example shows the results for tin(II) ethylhexanoate as an additive in polyphenylene sulfide. A PPS composition containing 0.58 weight percent (0.014 mol/Kg) tin(II) ethylhexanoate was prepared as follows. Fortron® 309 PPS (700 g), Fortron® 317 PPS (300 g), and tin(II) ethylhexanoate (6.48 g) were combined in a glass jar, manually mixed, and placed on a Stoneware bottle roller for 5 min. The resultant mixture was subsequently melt compounded using a Coperion 18 mm intermeshing co-rotating twin-screw extruder. The conditions of extrusion included a maximum barrel temperature of 300° C., a maximum melt temperature of 310° C., screw speed of 300 rpm, with a residence time of approximately 1 minute and a die pressure of 14-15 psi at a single strand die. The strand was frozen in a 6 ft tap water trough prior to being pelletized by a Conair chopper to give a pellet count of 100-120 pellets per gram. 896 g of the pelletized composition was obtained.

The viscosity and molecular weight of the pelletized composition were determined in the melt using the analytical techniques described above. Results are presented in Table 1.

### Example 2

### PPS Containing Tin(II) Ethylhexanoate and Zinc Oxide

This Example shows the results for tin(II) ethylhexanoate and zinc oxide as additives in polyphenylene sulfide. A PPS composition containing 0.58 weight percent (0.014 mol/Kg) tin(II) ethylhexanoate and 0.13 weight percent (0.016 mol/Kg) zinc oxide was prepared as described in Example 1, except that 6.48 grams of tin(II) ethylhexanoate and 1.30 grams of zinc oxide were combined with 700 g Fortron® 309 PPS and 300 g Fortron® 317 PPS. 866 Grams of the pelletized composition were obtained.

The viscosity and molecular weight of the pelletized composition were determined in the melt using the analytical techniques described above. Results are presented in Table 1.

### Example 3

### PPS Containing Tin(II) Ethylhexanoate and Zinc Stearate

This Example shows the results for tin(II) ethylhexanoate and zinc stearate as additives in polyphenylene sulfide. A PPS composition containing 0.58 weight percent (0.014 mol/Kg) tin(II) ethylhexanoate and 1.0 weight percent (0.016 mol/Kg) zinc stearate was prepared as described in Example 1, except that 6.48 grams of tin(II) ethylhexanoate and 10.12 grams of zinc stearate were combined with 700 g of Fortron® 309 PPS and 300 g of Fortron® 317 PPS. 873 Grams of the pelletized composition were obtained.

The viscosity and molecular weight of the pelletized composition were determined in the melt using the analytical techniques described above. Results are presented in Table 1.

### Example 4

### PPS Containing Tin(IV) Oxide and Tin(II) Stearate

This Example shows the results for tin(IV) oxide and tin(II) stearate as additives in polyphenylene sulfide. A PPS composition containing 0.24 weight percent (0.016 mol/kg) tin(IV) oxide and 1.1 weight percent 0.016 mol/kg) tin stearate was prepared as described in Example 1, except that 2.41 grams of tin(IV) oxide and 10.97 grams of tin(II) stearate were combined with 700 g of Fortron® 309 PPS and 300 g of Fortron® 317 PPS. 893 Grams of the pelletized composition were obtained.

The viscosity and molecular weight of the pelletized composition were determined in the melt using the analytical techniques described above. Results are presented in Table 1.

### Example 5

### PPS Containing Tin(II) Stearate

This Example shows the results for tin(II) stearate as an additive in polyphenylene sulfide. A PPS composition containing 1.1 weight percent (0.016 mol/Kg) tin stearate was prepared as described in Example 1, except that 10.97 grams of tin(II) stearate were combined with 700 g of Fortron® 309 PPS and 300 g of Fortron® 317 PPS. 797 Grams of the pelletized composition were yielded.

The viscosity and molecular weight of the pelletized composition were determined in the melt using the analytical techniques described above. Results are presented in Table 1.

### Example 6

### PPS Containing Zinc Stearate

This Example shows the results for zinc stearate as an additive in polyphenylene sulfide. A PPS composition containing 1.0 weight percent (0.016 mol/Kg) zinc stearate was prepared as described in Example 1, except that 10.12 grams of zinc stearate were combined with 700 g of Fortron® 309 PPS and 300 g of Fortron® 317 PPS. 784 grams of the pelletized composition were yielded.

The viscosity and molecular weight of the pelletized composition were determined in the melt using the analytical techniques described above. Results are presented in Table 1.

### Example 7

### PPS Containing Zinc Stearate and Tin(II) Oxide

This Example shows the results for zinc stearate and tin(II) oxide as additives in polyphenylene sulfide. A PPS composition containing 1.0 weight percent (0.016 mol/kg) zinc stearate and 0.22 weight percent (0.016 mol/Kg) tin(II) oxide was prepared as described in Example 1, except that 10.12 grams of zinc stearate and 2.16 grams of tin(II) oxide were combined with 700 g of Fortron® 309 PPS and 300 g of Fortron® 317 PPS. 860 grams of the pelletized composition were obtained.

The viscosity and molecular weight of the pelletized composition were determined in the melt using the analytical techniques described above. Results are presented in Table 1.

### Example 8

### PPS Containing Zinc Stearate and Zinc Oxide

This Example shows the results for zinc stearate and zinc oxide as additives in polyphenylene sulfide. A PPS composition containing 1.0 weight percent (0.016 mol/Kg) zinc stearate and 0.13 weight percent (0.016 mol/Kg) zinc oxide was prepared as described in Example 1, except that 10.12 grams of zinc stearate and 1.30 grams of zinc oxide were combined with 700 g of Fortron® 309 PPS and 300 g of Fortron® 317 PPS. 858 grams of the pelletized composition were obtained.

The viscosity and molecular weight of the pelletized composition were determined in the melt using the analytical techniques described above. Results are presented in Table 1.

### Example 9

### PPS Containing Zinc Acetate

This Example shows the results for zinc acetate as an additive in polyphenylene sulfide. A PPS composition containing 0.35 weight percent (0.016 mol/kg) zinc acetate dihydrate was prepared as described in Example 1, except that 3.51 grams of zinc acetate dihydrate were combined with 700 g of Fortron® 309 PPS and 300 g of Fortron® 317 PPS. 801 grams of the pelletized composition were obtained.

The viscosity and molecular weight of the pelletized composition were determined in the melt using the analytical techniques described above. Results are presented in Table 1.

### Example 10

### PPS Containing Tin(II) Stearate and Zinc Stearate

This Example shows the results for tin(II) stearate and zinc stearate as co-additives in polyphenylene sulfide. A PPS composition containing 1.0 weight percent (0.016 mol/kg) zinc stearate and 1.1 weight percent (0.016 mol/kg) tin(II) stearate was prepared as described in Example 1, except that 10.12 grams of zinc stearate and 10.97 grams of tin stearate were combined with 700 g of Fortron® 309 PPS and 300 g of Fortron® 317 PPS . 857 Grams of the pelletized composition were obtained.

The viscosity and molecular weight of the pelletized composition were determined in the melt using the analytical techniques described above. Results are presented in Table 1.

### Comparative Example A

### PPS Control (No Additives)

This Comparative Example is a control showing the results of polyphenylene sulfide without an additive, which is referred to as native PPS. A PPS composition was prepared as described in Example 1 using 700 g Fortron® 309 PPS and 300 g Fortron® 317 PPS but no other compounds were added. 829 Grams of the pelletized composition were obtained.

The viscosity and molecular weight of the pelletized composition were determined in the melt using the analytical techniques described above. Results are presented in Table 1.

### Comparative Example B

### PPS Containing Calcium Carbonate

This Comparative Example shows the results for calcium carbonate as an additive in polyphenylene sulfide. A PPS composition containing 0.16 weight percent (0.016 mol/kg) calcium carbonate was prepared as described in Example 1, except that 1.6 grams of calcium carbonate were combined with 700 g of Fortron® 309 PPS and 300 g of Fortron® 317 PPS. 743 grams of the pelletized composition were obtained.

The viscosity and molecular weight of the pelletized composition were determined in the melt using the analytical techniques described above. Results are presented in Table 1.

### Comparative Example C

### PPS Containing Calcium Stearate

This Comparative Example shows the results for calcium stearate as an additive in polyphenylene sulfide. A PPS composition containing 0.97 weight percent (0.016 mol/Kg) calcium stearate was prepared as described in Example 1, except that 9.71 grams of calcium stearate were combined with 700 g of Fortron® 309 PPS and 300 g of Fortron® 317 PPS. 815 grams of the pelletized composition were obtained.

The viscosity and molecular weight of the pelletized composition were determined in the melt using the analytical techniques described above. Results are presented in Table 1.

### Comparative Example D

### PPS Containing Calcium Acetate

This Comparative Example shows the results for calcium acetate as an additive in polyphenylene sulfide. A PPS composition containing 0.25 weight percent (0.016 mol/Kg) calcium acetate dihydrate was prepared as described in Example 1, except that 2.53 grams of calcium acetate dihydrate were combined with 700 g of Fortron® 309 PPS and 300 g of Fortron® 317 PPS. 806 grams of the pelletized composition were obtained.

The viscosity and molecular weight of the pelletized composition were determined in the melt using the analytical techniques described above. Results are presented in Table 1.

TABLE 1

| | | | Complex | | MW after 2 hours | |
|---|---|---|---|---|---|---|
| | | | Viscosity | Change in | of aging | |
| | | Initial | at 180 s | Complex | at 320° C. | |
| | | MW | in nitrogen | Viscosity | in nitrogen | Retention |
| Sample | Additive(s) | (g/mol) | (Pa.s) | (%) | (g/mol) | (%) |
| Ex 1 | tin | 57,000 | 120 | −52 | 49,000 | 86 |
| | ethylhexanoate | | | | | |
| Ex 2 | tin | 59,000 | 140 | −44 | 51,000 | 86 |
| | ethylhexanoate + | | | | | |
| | zinc oxide | | | | | |
| Ex 3 | tin | 58,000 | 120 | −52 | 54,000 | 93 |
| | ethylhexanoate + | | | | | |
| | zinc stearate | | | | | |
| Ex 4 | tin (IV) oxide + | 56,000 | 150 | −40 | 50,000 | 89 |
| | tin stearate | | | | | |
| Ex 5 | tin stearate | 60,000 | 110 | −56 | 46,000 | 77 |
| Ex 6 | zinc stearate | 60,000 | 190 | −24 | 57,000 | 95 |
| Ex 7 | zinc stearate + | 60,000 | 180 | −28 | 59,000 | 98 |
| | tin(II) oxide | | | | | |
| Ex 8 | zinc stearate + | 60,000 | 200 | −20 | 57,000 | 95 |
| | zinc oxide | | | | | |
| Ex 9 | zinc acetate | 60,000 | 210 | −16 | 55,000 | 92 |
| Ex 10 | tin stearate + | 60,000 | 120 | −52 | 52,000 | 87 |
| | zinc stearate | | | | | |
| Comp Ex A | — | 60,000 | 250 | 0 | 46,000 | 77 |
| Comp Ex B | calcium | 61,000 | 280 | 12 | 45,000 | 74 |
| | carbonate | | | | | |
| Comp Ex C | calcium | 60,000 | 270 | 8 | 49,000 | 82 |
| | stearate | | | | | |
| Comp Ex D | calcium acetate | 58,000 | 270 | 8 | 49,000 | 84 |

The Examples show a decrease in viscosity relative to the native polyphenylene sulfide while maintaining at least 77% retention of the molecular weight after aging for 2 hours at 320° C. in nitrogen. Examples 1, 2, and 3 with tin(II) ethylhexanoate show a decrease in viscosity relative to the native polyphenylene sulfide while maintaining at least 85% retention of the molecular weight after aging for 2 hours at 320° C. in nitrogen. Comparative Examples B, C, and D show an increase in viscosity relative to the native polyphenylene sulfide while maintaining at least a 74% retention of the molecular weight after aging for 2 hours at 320° C. in nitrogen. Comparative Example A, containing native PPS (without any additives), shows a 77% retention of molecular weight after aging for 2 hours at 320° C. in nitrogen.

Although particular embodiments of the present invention have been described in the foregoing description, it will be understood by those skilled in the art that the invention is capable of numerous modifications, substitutions, and rearrangements without departing from the spirit of essential attributes of the invention. Reference should be made to the appended claims, rather than to the foregoing specification, as indicating the scope of the invention.

What is claimed is:

1. A method for decreasing the complex viscosity of a polymer composition comprising polyarylene sulfide comprising:
combining
a) a polyarylene sulfide having a weight average molecular weight in the range of about 50,000 g/mol to about 80,000 g/mol and a complex viscosity in the range of about 200 Pa·s to about 900 Pa·s when measured according to the Complex Viscosity Test defined herein; and
b) at least one additive selected from the group consisting of tin(IV) oxide, tin(II) oxide, tin(II) stearate, zinc stearate, zinc acetate, zinc oxide, a branched tin(II) carboxylate; and mixtures thereof, to form a polymer composition.

2. The method of claim 1, wherein the additive comprises zinc acetate and the complex viscosity of the composition is decreased by about 10% to about 20% relative to the complex viscosity of the native polyarylene sulfide measured under the same conditions.

3. The method of claim 1, wherein the additive comprises zinc stearate and the complex viscosity of the composition is decreased by about 20% to about 30% relative to the complex viscosity of the native polyarylene sulfide measured under the same conditions.

4. The method of claim 1, wherein the additive comprises tin(II) stearate and the complex viscosity of the composition is decreased by at least 40% relative to the complex viscosity of the native polyarylene sulfide measured under the same conditions.

5. The method of claim 1, wherein the additive comprises a branched tin(II) carboxylate selected from the group consisting of Sn(O₂CR)₂, Sn(O₂CR)(O₂CR′), Sn(O₂CR)(O₂CR″), and mixtures thereof, where the carboxylate moieties O₂CR and O₂CR′ independently represent branched carboxylate anions and the carboxylate moiety O₂CR″ represents a linear carboxylate anion.

6. The method of claim 5, wherein the additive further comprises a linear tin(II) carboxylate Sn(O₂CR″)₂ and where R″ is a primary alkyl group comprising from 6 to 30 carbon atoms.

7. The method of claim 5, wherein the tin(II) carboxylate comprises Sn(O₂CR)₂, Sn(O₂CR)(O₂CR′), or mixtures thereof, and the radicals R or R′ independently or both have a structure represented by Formula (I), 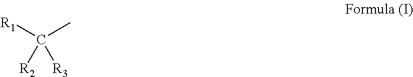
wherein R₁, R₂, and R₃ are independently:
H,
a primary, secondary, or tertiary alkyl group having from 6 to 18 carbon atoms, optionally substituted with fluoride, chloride, bromide, iodide, nitro, hydroxyl, and carboxyl groups;
an aromatic group having from 6 to 18 carbon atoms, optionally substituted with alkyl, fluoride, chloride, bromide, iodide, nitro, hydroxyl, and carboxyl groups; and
a cycloaliphatic group having from 6 to 18 carbon atoms, optionally substituted with fluoride, chloride, bromide, iodide, nitro, hydroxyl, and carboxyl groups;
with the proviso that when R₂ and R₃ are H, R₁ is:
a secondary or tertiary alkyl group having from 6 to 18 carbon atoms, optionally substituted with fluoride, chloride, bromide, iodide, nitro, hydroxyl, and carboxyl groups;
an aromatic group having from 6 to 18 carbons atoms and substituted with a secondary or tertiary alkyl group having from 6 to 18 carbon atoms, the aromatic group and/or the secondary or tertiary alkyl group being optionally substituted with fluoride, chloride, bromide, iodide, nitro, hydroxyl, and carboxyl groups; and
a cycloaliphatic group having from 6 to 18 carbon atoms, optionally substituted with fluoride, chloride, bromide, iodide, nitro, hydroxyl, and carboxyl groups.

8. The method of claim 7, wherein the radicals R or R′ or both have a structure represented by Formula (I), and R₃ is H.

9. The method of claim 5, wherein the tin(II) carboxylate comprises Sn(O₂CR)₂, Sn(O₂CR)(O₂CR′), or mixtures thereof, and the radicals R or R′ or both have a structure represented by Formula (II), 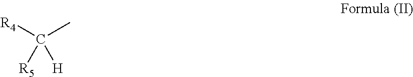
wherein
R₄ is a primary, secondary, or tertiary alkyl group having from 4 to 6 carbon atoms, optionally substituted with fluoride, chloride, bromide, iodide, nitro, and hydroxyl groups; and
R₅ is a methyl, ethyl, n-propyl, sec-propyl, n-butyl, sec-butyl, or tert-butyl group, optionally substituted with fluoride, chloride, bromide, iodide, nitro, and hydroxyl groups.

10. The method of claim 5, wherein the tin(II) carboxylate comprises Sn(O₂CR)₂, and R has a structure represented by Formula (II), where R₄ is n-butyl and R₅ is ethyl.

11. The method of claim 9, wherein the complex viscosity of the polymer composition is decreased by at least about 40% relative to the complex viscosity of the native polyarylene sulfide measured under the same conditions.

12. The method of claim 5, further comprising combining at least one zinc(II) compound and/or zinc metal with the additive and the polyarylene sulfide.

13. The method of claim 12, wherein the zinc(II) compound comprises zinc stearate, the additive comprises Sn(O₂CR)₂, and R has a structure represented by Formula (II) 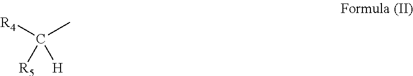
where R₄ is n-butyl and R₅ is ethyl.

14. The method of claim 1, wherein the additive is present in the polymer composition at a concentration of about 5 weight percent or less, based on the weight of the polyarylene sulfide.

15. The method of claim 1, wherein the polyarylene sulfide is polyphenylene sulfide.

16. The method of claim 1 wherein the weight average molecular weight of the polyarylene sulfide is maintained; the complex viscosity of the composition is decreased compared to that of the native polyarylene sulfide measured under the same conditions; and the retention of the weight average molecular weight of the polyarylene sulfide in the composition is at least about 77% when measured according to the Accelerated Aging Test defined herein.
